(19) United States
(12) Patent Application Publication
(10) Pub. No.: US 2003/0035399 A1
(43) Pub. Date: Feb. 20, 2003

(54) Apparatus and method for data communication

(75) Inventors: Yasuhito Ishibashi, Tokyo (JP); Takero Kobayashi, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/202,073

(22) Filed: Jul. 23, 2002

(30) Foreign Application Priority Data
Jul. 31, 2001 (JP) 2001-232148

(51) Int. Cl. H04Q 7/00; H04Q 7/24

(52) U.S. Cl. 370/338; 370/328

(57) ABSTRACT

A wireless terminal connects, via wireless communication, with an AP having a relay function between a wireless LAN and other networks. The wireless terminal acquires from the AP configuration information required to configure the wireless terminal to use a particular network environment. The wireless terminal may further acquire from the AP configuration information required to configure particular software applications for use in a particular network environment. When connecting with the AP, the wireless terminal can automatically acquire the configuration information previously stored in a database. The configuration information includes, for example, configuration information required for the wireless terminal to connect with a wired LAN and configuration information required by particular software applications to run in the wired LAN environment.

### CROSS-REFERENCE TO RELATED APPLICATIONS

This application is based upon and claims the benefit of priority from the prior Japanese Patent Application No. 2001-232148, filed Jul. 31, 2001, the entire contents of which are incorporated herein by reference.

### BACKGROUND OF THE INVENTION

1. Field of the Invention

This invention relates generally to an electronic apparatus which has a relay function between a terminal unit and a network, and more particularly to techniques for an access point which has a relay function between a wireless network and a wired network.

2. Description of the Related Art

In recent years, the construction of wireless networks conforming to the IEEE 802.11 standard, a typical wireless LAN standard, has been promoted. This type of wireless network is composed of a plurality of wireless terminals and network connecting units known as access points (hereinafter referred to as APs). A wireless terminal is a terminal unit with a wireless communication function (such as a personal computer or a mobile information apparatus, including a mobile phone). An AP corresponds to a wireless base station which has a relay function (or a bridge function) between a wireless LAN and a wired LAN. Specifically, it performs as a bridge or router.

An AP has the function of informing each wireless terminal nearby of ID information for identifying a group of APs, called ESSID (extended service set identity). A wireless terminal can connect to a desired AP, using the ESSID provided by the AP.

With this process, the wireless terminal can connect to the AP through wireless communication and perform data communication with the desired wireless LAN. However, to connect with a wired LAN relayed with APs or an external public telecommunication network and use the network environment, the user has to get the network supervisor to give him or her the specific configuration information to allow the wireless terminal to access the network and the configuration information for enabling applications on the wireless terminal to be used on the network, including, for example, a mail program and an Internet browser. Then, the user does the work of entering the configuration information in each of the specific items of each application.

One known mechanism for acquiring configuration information for using a network is a protocol known as DHCP (dynamic host configuration protocol). When a terminal, a client, is initiated, a DHCP server informs the terminal of the IP (Internet Protocol), gateway address, subnetwork mask, and other configuration information offered for use under the IP network environment. However, neither the configuration information for other networks, nor additional information necessary to configure an application (for example, an Internet browser or a mail program) can be offered. Therefore, it is difficult for the aforementioned wireless terminal to acquire the configuration information necessary to use each network.

A technique related to a client/server system has been disclosed which has a correlation table for a plurality of proxy servers and communication modules corresponding to them. The communication modules are selected automatically when connecting a client application and a server application (for example, refer to Jpn. Pat. Appln. KOKAI Publication No. 2000-101640). In the prior art technique, however, the client side must have a connection correlation table beforehand. Therefore, such a correlation table must be prepared for the client side in advance.

### BRIEF SUMMARY OF THE INVENTION

Embodiments of the present invention provide a network connection apparatus and method for providing to a network enabled device (such as a wireless terminal) configuration information for various networks and configuration information required for software applications to run on various networks.

According to embodiments of the invention, an AP having a relay function between a wireless LAN and other networks is provided. A wireless terminal acquires from the AP configuration information required to configure the wireless terminal to use a particular network environment.

According to further embodiments of the invention, the wireless terminal may also acquire from the AP configuration information required to configure particular software applications for use in a particular network environment.

When connecting with the AP, the wireless terminal can automatically acquire the configuration information previously stored in a database. The configuration information includes, for example, configuration information required for the wireless terminal to connect with a wired LAN and configuration information required by particular software applications to run in the wired LAN environment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a system in which embodiments of the present invention may be employed;

FIG. 2 illustrates a software configuration employed in the system shown in FIG. 1, according to an embodiment of the present invention;

FIG. 3 is a flowchart illustrating a communication procedure, according to an embodiment of the present invention;

FIG. 4 illustrates a software configuration employed in the system shown in FIG. 1, according to an embodiment of the present invention;

FIG. 5 is a block diagram showing the configuration of a system in which embodiments of the present invention may be employed;

FIG. 6 illustrates a software configuration employed in the system shown in FIG. 1, according to an embodiment of the present invention; and

FIG. 7 illustrates exemplary configuration information, according to an embodiment of the present invention.

### DETAILED DESCRIPTION OF THE INVENTION

Hereinafter, referring to the accompanying drawings, embodiments of the present invention will be described.

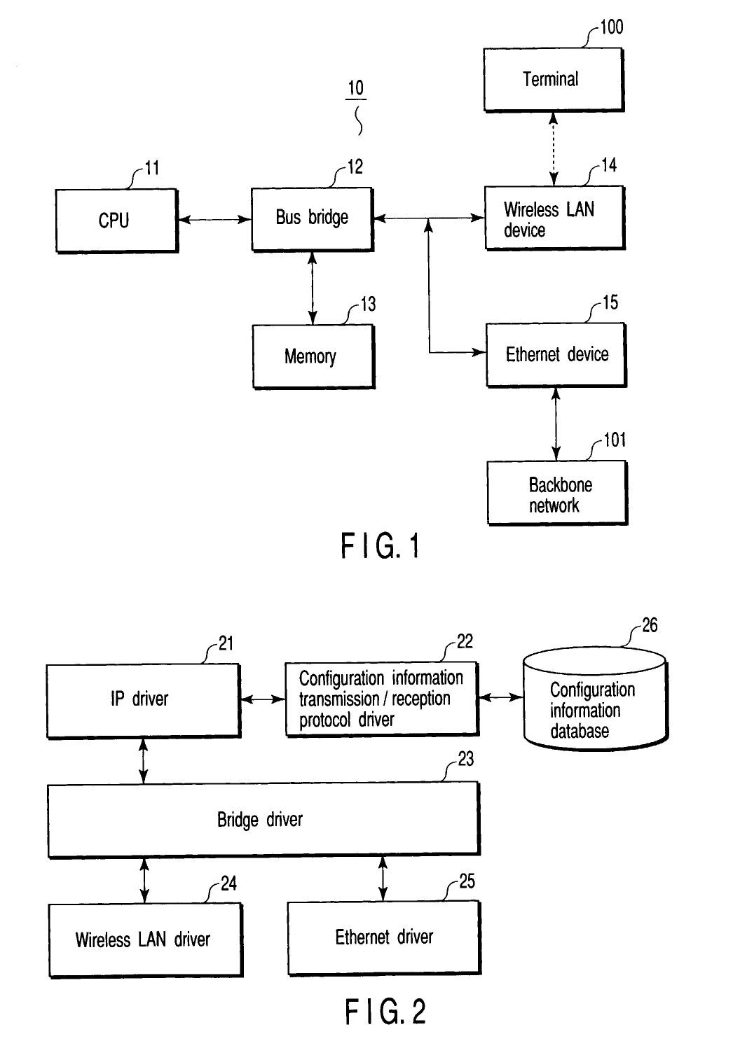

FIG. 1 is a block diagram showing the configuration of a system 10 in an access point (AP), according to an embodiment of the present invention. The system 10 includes components providing functionality which corresponds to a base station 10 for relaying data communication between a wireless LAN and a wired LAN.

In FIG. 1, a CPU 11 executes a program loaded into a memory 13, thereby realizing a relay function between a wireless LAN and a wired LAN. Specifically, the CPU 11 controls a wireless LAN device 14 and an Ethernet device 15 and manages configuration information (including configuration information for software applications), which will be described later.

A bus bridge 12 monitors a CPU bus connected to the CPU 11, a memory bus connected to the memory 13, and a PCI bus for communicating with each of the devices 14 and 15 and manages transmission and reception between the buses. In addition to the program for the CPU 11, the memory 13 constitutes a database in which is stored configuration information for using the network (including configuration information for software applications).

The wireless LAN device 14, which complies with, for example, the IEEE 802.11b standard, manages wireless data communication with a wireless terminal 100 connected to the wireless LAN. The wireless terminal 100 corresponds to, for example, a personal computer with a wireless communication function, a mobile information unit, including a mobile phone, a personal digital assistant (PDA), or the like. The Ethernet device 15 manages data communication with a trunk network 101 composed of, for example, a wired LAN in an office or the like.

Next, referring to FIG. 2, a software configuration of the system 10 according to a first embodiment of the present invention will be described.

An IP (Internet Protocol) driver 21 manages IP datagrams (IP packets). A configuration information transmission/reception protocol driver 22 is the software for controlling the process of transmitting and receiving the configuration information provided using an IP-level protocol. The configuration information transmission/reception protocol driver 22 includes a function of searching a configuration information database 26. The configuration information database 26 stores configuration information previously provided by, for example, a network supervisor or the like. According to embodiments of the present invention, the configuration information includes information for configuring software applications, as well as addresses and other information required to configure the wireless terminal 100 to use the trunk network 101.

The configuration information will now be described. Examples of configuration information are shown in FIG. 7. This configuration information, which is related to the configuration of applications, includes, for example, information for a web browser about proxy servers, information about time zones and other information such as the address for the main web page that appears when the web browser is first executed. According to one embodiment of the present invention, configuration information transmission/reception protocol driver 22 searches for information for configuring software applications from a set of such information (such as that shown in FIG. 7) contained in configuration information database 26. However, according to other embodiments of the present invention, configuration information database 26 may include two or more such sets of configuration information. In this case, configuration information transmission/reception protocol driver 22 may include the added function of searching for particular sets from which to acquire configuration information.

By transmitting such configuration information to the wireless terminal 100 which has established communication with the AP, the wireless terminal 100 configures the application automatically according to the acquired configuration information, which enables the application software to be used on the network.

Referring again to FIG. 2, a bridge driver 23, functioning in the link layer, manages the transmission and reception of packets at a MAC (media access control) level between the wireless LAN and the wired LAN and delivers IP packets addressed to the AP to the IP driver 21, functioning in the network layer. A wireless LAN driver 24, functioning at the physical layer, controls the wireless LAN device 14, thereby providing a wireless LAN AP function. An Ethernet driver 25, also functioning at the physical layer, controls the Ethernet device 15, thereby managing packet communication with the wired LAN.

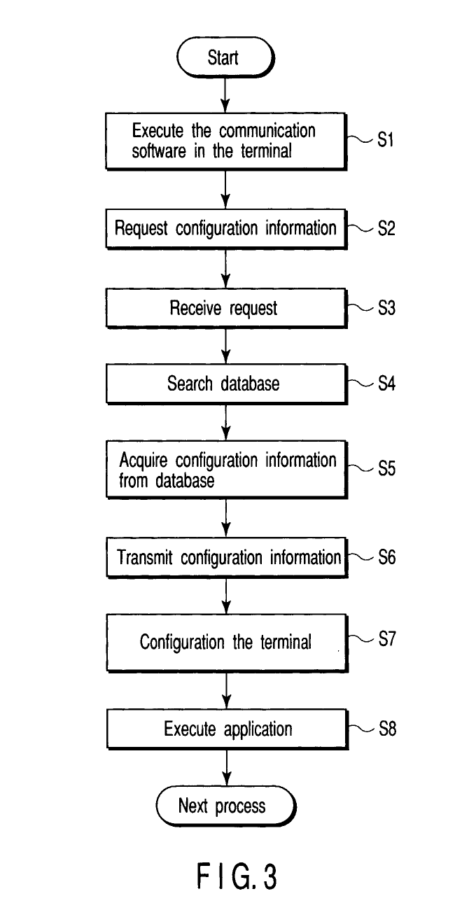

Referring now mainly to the flowchart in FIG. 3, the procedure for communicating between an AP and a wireless terminal according to embodiments of the present invention will be described.

According to embodiments of the present invention, it is assumed that the wireless terminal 100 includes communication software firmware and/or hardware for connecting to an AP and acquiring configuration information for a wired LAN. It is also assumed that the wireless terminal 100 includes software, firmware and/or hardware that automatically configures the wireless terminal 100, including particular software used by the wireless terminal 100, according to the acquired configuration information.

To begin the procedure, the communication software of the wireless terminal 100 is executed, thereby establishing wireless data communication with the AP via the wireless LAN device 14 (S1). The communication software of the wireless terminal 100 then requests from the AP configuration information needed to use the wired LAN (S2).

Receiving a configuration information request packet via the wireless LAN driver 24, the bridge driver 23 delivers the configuration information request packet to the IP driver 21 (S3). IP driver 21 functions as a driver of the configuration information. IP driver 21 receives data from Bridge driver 23 and determines whether the data is normal data for communication or a request for configuration information. If IP driver 21 determines that the data is a request for configuration information, then under the control of the IP driver 21, the configuration information transmission/reception protocol driver 22 searches for the requested configuration information in database 26 (S4). The IP driver 21 transfers to the bridge driver 23 any configuration information acquired from the configuration information database 26 by the configuration information transmission/reception protocol driver 22 (S5). The wireless LAN driver 24 transmits the configuration information from the bridge driver 23 to the wireless terminal 100 via wireless communication (S6). The wireless terminal 100 then automatically configures the application software according to the configuration information acquired from the AP in order to make the software usable on the network.

According to the above-described communication procedure, the configuration information required to use the network environment are set in the wireless terminal 100 (S7). Since the configuration information includes the configuration information for a specific application, the wireless terminal 100 can execute each type of application using the network connected to the Ethernet device 15 via the AP (S8).

As an example, configuration information may be provided for specific applications including, but not limited to, a mail program for providing electronic mail usable on a network connected to a wired LAN, a web browser, a program for receiving news items, software for using a virtual private network environment (VPN) and software for using a mobile network.

In the embodiment of the present invention shown in FIG. 2, the function of driving the configuration information is performed by IP driver 21 in the network layer. This is advantageous in that in the absence of IP driver 21, the function of driving the configuration information would be performed by the wireless LAN driver 24 in the link layer. This would require expanding the Ethernet standard or the IEEE 802.11 standard for the wireless LAN driver 24, to and from the wireless terminal 100, to include the function of driving the configuration information. By including IP driver 21, this expansion of the Ethernet standard or the IEEE 802.11 standard for the wireless LAN driver 24 is not required.

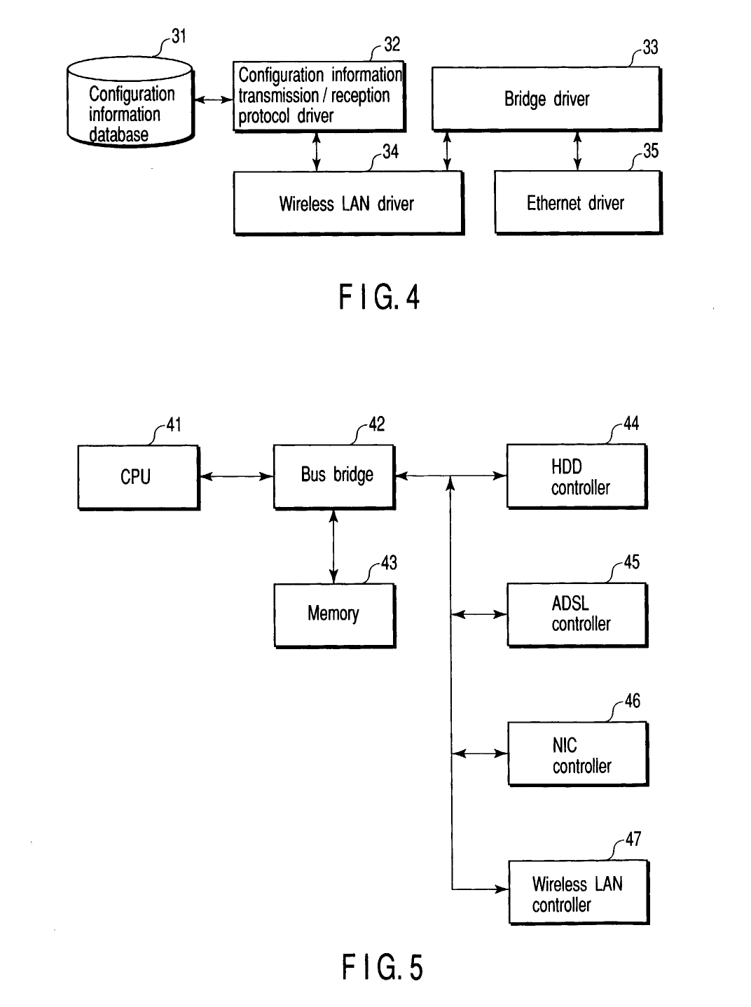

Referring to FIG. 4, a software configuration of the system 10 according to a second embodiment of the present invention will be described. In the second embodiment, the function of driving the configuration information performed by IP driver 21 according to the first embodiment, is, according to the second embodiment, performed by wireless LAN driver 34, functioning at the link level. Specifically, in the second embodiment wireless LAN driver 34 controls the process of transmitting and receiving provided configuration information using a protocol obtained by expanding the Ethernet standard or the IEEE 802.11 standard, to and from the wireless terminal 100.

According to the second embodiment, the communication software of the wireless terminal 100 is executed, thereby establishing wireless data communication with the AP via the wireless LAN device 14. The communication software of the wireless terminal 100 then requests from the AP configuration information needed to use the network by sending a configuration information request packet to the wireless LAN driver 34. Under the control of the wireless LAN driver 34, the configuration information transmission/reception protocol driver 32 searches for the requested configuration information in database 26. The configuration information transmission/reception protocol driver 32 transmits any configuration information acquired from the database 31 to the wireless terminal 100 via wireless LAN driver 34. The wireless terminal 100 then automatically configures the application software according to the configuration information acquired from the AP in order to make the software usable on the network.

In the second embodiment of the software configuration of the system 10, the configuration information is the same as that described above for the first embodiment of the software configuration. Specifically, the configuration information database 31 stores configuration information previously provided by, for example, a network supervisor or the like. The configuration information includes information for configuring applications, as well as addresses and other information required to configure the wireless terminal 100 to use the network. As discussed above in reference to the first embodiment, configuration information database 31 may include one or more sets of configuration information that may be searched.

The bridge driver 33 manages the transmission and reception of packets at the MAC level between a wireless LAN and a wired LAN. The wireless LAN driver 34 controls the wireless LAN device 14, thereby providing a wireless LAN AP function. The Ethernet driver 35 controls the Ethernet device 15, thereby managing packet communication with the wired LAN.

In the embodiment of the present invention shown in FIG. 4, the function of driving the configuration information is performed by wireless LAN driver 34 in the link layer. According to the second embodiment, the Ethernet standard or the IEEE 802.11 standard for the wireless LAN driver 34 must be expanded to perform this function. However, in some applications it may be advantageous to do this and eliminate the additional data communication traffic that is required between the link layer (Bridge driver 23) and the network layer (IP driver 21) if the IP driver 21 is added to perform this function, as shown in FIG. 2.

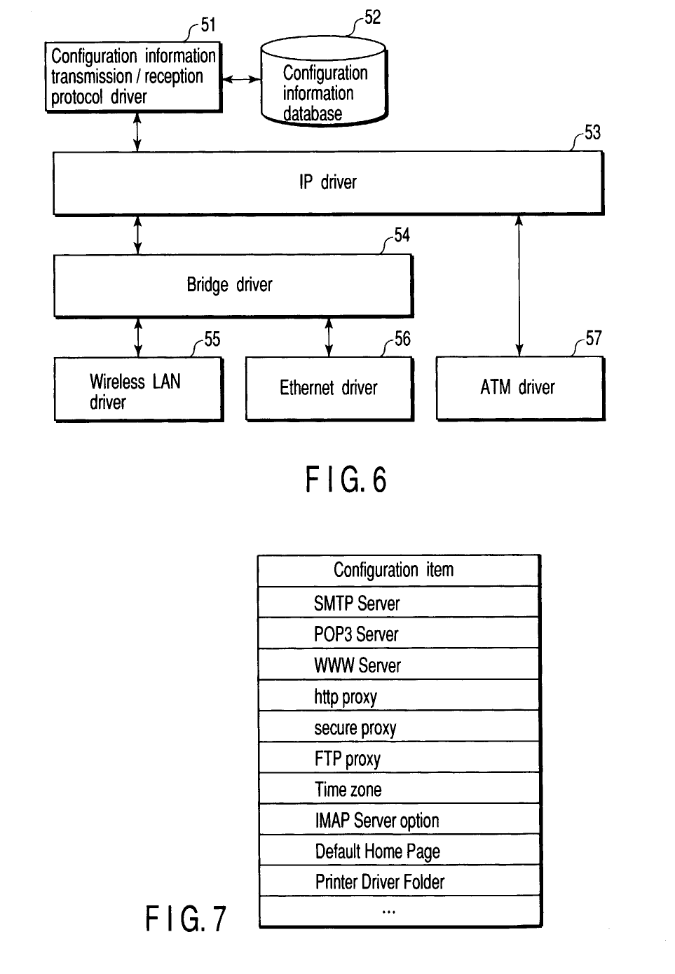

Referring to FIG. 6, a software configuration of the system 10 according to a third embodiment of the present invention will be described. In the third embodiment, a configuration information transmission/reception protocol driver 51 controls the process of transmitting and receiving the provided configuration information using an IP-level protocol. In addition, as in the first and second embodiments, the configuration information transmission/reception protocol driver 51 searches a configuration information database 52 and thereby retrieves configuration information requested by the wireless terminal 100. The configuration information database 52 stores the configuration information previously provided by, for example, a network supervisor or the like. The configuration information includes information for configuring applications, as well as addresses and other information required to configure the wireless terminal 100 to use the network. As discussed above in reference to the first and second embodiments, configuration information database 52 may include one or more sets of configuration information that may be searched.

An IP driver 53 manages the transmission and reception of IP packet data, thereby controlling the transmission and reception of IP data packets between a bridge driver 54 and an ATM (asynchronous transfer mode) driver 57. The bridge driver 54 manages the transmission and reception of packets at the MAC level between the wireless LAN and the wired LAN and delivers to the IP driver 53 IP packets addressed to the AP or another subnetwork. A wireless LAN driver 55 controls the wireless LAN device 14, thereby providing a wireless LAN AP function. An Ethernet driver 56 controls the Ethernet device 15, thereby managing packet communication with the wired LAN.

The ATM driver 57 divides the packets from the IP driver 53 into cells which can be transmitted and received in ATM and sends the cells to an ATM port or bundles the cells from the ATM port into packets and transmits the packets to the IP driver 53.

Referring to FIG. 5, an alternative embodiment of system 10 is shown wherein embodiments of the present invention may be employed.

In FIG. 5, a CPU 41 executes the program loaded into a memory 43, thereby controlling the processing of various drivers and protocols. A bus bridge 42 manages transmission and reception between the CPU 41, memory 43, and various types of devices 44 to 47 explained below. The memory 43 is used for temporarily storing not only the program for the CPU 41 but also the packet data exchanged between the various devices 44 to 47.

The HDD controller 44 is an interface for a HDD (hard disk drive) (not shown) used to store the program for the CPU 41 and the certification data (such as ESSID). An ADSL (asymmetric digital subscriber line) controller 45 is provided as an interface for connecting with the Internet, for example with an Internet server, via an ADSL channel. A NIC (network interface card) controller 46 is provided as an interface for connecting with a wired LAN. A wireless LAN controller 47 is provided as an interface for connecting with the wireless LAN.

As described above, a wireless terminal may connect, via wireless communication, with an AP having a relay function between a wireless LAN and a wired LAN. Embodiments of the present invention described above provide an apparatus and method for enabling a wireless terminal to acquire from the AP configuration information required to configure the wireless terminal to use a particular network environment. In addition, embodiments of the present invention described above provide an apparatus and method for enabling a wireless terminal to acquire from the AP configuration information required to configure particular software applications for use in a particular network environment.

Accordingly, in contrast to an IP network environment based on the conventional DHCP technique, embodiments of the present invention enable the wireless terminal to receive configuration information for a particular network, for example a wired LAN, and to receive configuration information for software applications to be used in the particular network environment.

Specifically, when connecting with an AP, a wireless terminal can automatically acquire the configuration information previously stored in a database. The configuration information includes, for example, configuration information required for the wireless terminal to connect with a network and configuration information required by particular software applications to run in the network environment. Therefore, the wireless terminal can use not only the wireless LAN via the AP but also various services on the network.

In other words, according to embodiments of the present invention, it is possible to provide a network connecting apparatus and method which comprises an AP for providing configuration information for particular networks and for applications to be used in particular network environments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for data communication, comprising:
relay means for relaying data communication between a terminal unit having a communication function and a communication unit;
communication means for communicating with said terminal unit;
a storage section for storing configuration information required to configure said terminal unit for data communication with said communication unit; and
a control section which transmits said configuration information from said storage section to said terminal unit via said communication means.

2. The apparatus according to claim 1, wherein
said communication means comprises wireless communication means and said communication unit is a unit on a network to which the apparatus is connected.

3. The apparatus according to claim 1, wherein
said communication means comprises wired communication means and said communication unit is a unit on a network to which the apparatus is connected.

4. The apparatus according to claim 1, wherein
said configuration information includes at least one of configuration information required to configure said terminal unit to execute a software application, configuration information required to configure said terminal unit to use a virtual private network (VPN), and configuration information required to configure said terminal unit to use a mobile network; and
wherein said software application includes at least one of a mail program, a web browser, and a program for receiving news.

5. The apparatus according to claim 2, wherein
said configuration information includes at least one of configuration information required to configure said terminal unit to execute a software application, configuration information required to configure said terminal unit to use a virtual private network (VPN), and configuration information required to configure said terminal unit to use a mobile network; and
wherein said software application includes at least one of a mail program, a web browser, and a program for receiving news.

6. The apparatus according to claim 3, wherein
said configuration information includes at least one of configuration information required to configure said terminal unit to execute a software application, configuration information required to configure said terminal unit to use a virtual private network (VPN), and configuration information required to configure said terminal unit to use a mobile network; and
wherein said software application includes at least one of a mail program, a web browser, and a program for receiving news.

7. The apparatus according to claim 1, wherein
said communication unit is an Internet server, and said configuration information includes at least one of information about a proxy server and time zone information.

8. The apparatus according to claim 2, wherein
said communication unit is an Internet server, and said configuration information includes at least one of information about a proxy server and time zone information.

9. The apparatus according to claim 3, wherein
said communication unit is an Internet server, and said configuration information includes at least one of information about a proxy server and time zone information.

10. The apparatus according to claim 4, wherein
said communication unit is an Internet server, and said configuration information further includes at least one of information about a proxy server and time zone information.

11. In a data communication apparatus for relaying data communication between a terminal unit and a communication unit, said terminal unit having a communication function and said data communication apparatus having a storage section, a method for data communication, said method comprising:
establishing communication with said terminal unit;
after communication with said terminal unit is established, acquiring from said storage section configuration information required to configure said terminal unit for data communication with said communication unit; and
transmitting said configuration information to said terminal unit.

12. The method according to claim 11, wherein the configuration information is acquired from said storage section and transmitted to said terminal unit in response to a request for said configuration information from said terminal unit.

13. In a network system having a communication terminal and a communication unit, a device having a relay for performing data communication between said communication terminal and said communication unit, the device comprising:
first communication means for performing communication between said communication terminal and said communication unit;
a storage section for storing configuration information required to configure said communication terminal for data communication with said communication unit; and
a control section which transmits said configuration information from said storage section to said communication terminal via said communication means;
wherein said communication terminal includes
second communication means capable of communicating with said first communication means, and
configuration means for configuring at least one software application according to said configuration information transmitted from said communication means.

14. In a network system having a communication terminal and a communication unit, a device having a relay for performing data communication between said communication terminal and said communication unit, the device further having communication means for communicating with said communication terminal and a storage section for storing configuration information required to configure said communication terminal for data communication with said communication unit, a method for data communication comprising:
receiving a request for said configuration information from said communication terminal;
acquiring said configuration information from said storage section according to said request; and
transmitting said configuration information to said communication terminal via said communication means.

15. The method according to claim 14, wherein
said communication means comprises wireless communication means and said communication unit is a unit on a network to which the device is connected.

16. The method according to claim 14, wherein
said communication means is wired communication means and said communication unit is a unit on a network to which the device is connected.

17. The method according to claim 14, wherein
said configuration information includes at least one of configuration information required to configure said communication terminal to execute a software application, configuration information required to configure said communication terminal to use a virtual private network (VPN), and configuration information required to configure said communication terminal to use a mobile network, and
wherein said software application includes at least one of a mail program, a web browser, and a program for receiving news.
